(19) United States
(12) Patent Application Publication
(10) Pub. No.: US 2012/0052394 A1
(43) Pub. Date: Mar. 1, 2012

(54) POSITIVE ELECTRODE FOR NON-AQUEOUS ELECTROLYTE SECONDARY BATTERY AND NON-AQUEOUS ELECTROYLTE SECONDARY BATTERY USING THE POSITIVE ELECTRODE

(75) Inventors: Tadayoshi Tanaka, Osaka (JP); Hiroshi Minami, Kobe-shi (JP); Naoki Imachi, Kobe-shi (JP)

(73) Assignee: SANYO ELECTRIC CO., LTD., Osaka (JP)

(21) Appl. No.: 13/217,980

(22) Filed: Aug. 25, 2011

(30) Foreign Application Priority Data
Aug. 30, 2010 (JP) 2010-191815

(51) Int. Cl. H01M 2/16

(52) U.S. Cl. 429/246

(57) ABSTRACT

A positive electrode for a non-aqueous electrolyte secondary battery is provided. The positive electrode has a positive electrode current collector, a positive electrode mixture layer formed on at least one surface of the positive electrode current collector and containing a positive electrode active material, and an inorganic particle layer formed on the positive electrode mixture layer. The inorganic particle layer contains inorganic particles, lithium phosphate, and a water-based binder.

### BACKGROUND OF THE INVENTION

1. Field of the Invention

The present invention relates to a positive electrode for a non-aqueous electrolyte secondary battery and a battery using the positive electrode.

2. Description of Related Art

Rapid advancements in size and weight reductions of mobile information terminal devices such as mobile telephones, notebook computers, and PDAs in recent years have created demands for higher capacity batteries as driving power sources for such devices. The capacity of lithium-ion secondary batteries, which have high energy density among the secondary batteries, has increased year by year. Employing higher voltage to increase the utilization factor of the positive electrode active material has also been used as a means to increase the capacity of the batteries. However, higher voltage results in decomposition of the separator and the non-aqueous electrolyte, causing the positive electrode components to dissolve away. As a consequence, the storage performance and safety of the batteries have tended to lower. For this reason, development of the elemental technology for assuring the storage performance and safety has been actively pursued.

For example, Japanese Patent No. 3371301 and Published PCT application No. WO 2005/057691 A1 propose techniques for improving reliability and safety by forming a porous insulating layer on a surface of the positive electrode or the negative electrode. Japanese Published Unexamined Patent Application Nos. 2007-280917 and 2007-280918 propose techniques for improving the high-temperature storage performance of a high voltage battery, in addition to improving the safety, by forming an inorganic particle layer on a specific electrode surface. Japanese Published Unexamined Patent Application No. 9-306547 proposes a technique for improving the storage performance of a battery by adding lithium phosphate to the positive electrode.

However, a problem has been that merely forming an inorganic particle layer on an electrode surface or adding lithium phosphate to the positive electrode cannot improve the storage performance dramatically while preventing charge-discharge performance from deteriorating.

### BRIEF SUMMARY OF THE INVENTION

Accordingly, the present invention provides a positive electrode for a non-aqueous electrolyte secondary battery comprising: a positive electrode current collector; a positive electrode mixture layer formed on at least one surface of the positive electrode current collector and containing a positive electrode active material; and an inorganic particle layer formed on the positive electrode mixture layer, the inorganic particle layer containing inorganic particles, a phosphate salt, and a binder.

The present invention achieves a dramatic improvement in storage performance, especially storage performance at high temperatures.

### DETAILED DESCRIPTION OF THE INVENTION

According to the invention, the positive electrode for a non-aqueous electrolyte secondary battery comprises: a positive electrode current collector; a positive electrode mixture layer formed on at least one surface of the positive electrode current collector and containing a positive electrode active material; and an inorganic particle layer formed on the positive electrode mixture layer, the inorganic particle layer containing inorganic particles, a phosphate salt, and a binder.

It is desirable that the phosphate salt be lithium phosphate.

It is desirable that the binder be a water-based binder.

When preparing a non-aqueous electrolyte secondary battery, N-methyl-2-pyrrolidone (NMP) is commonly used as the solvent for the slurry used for formation of the positive electrode mixture layer. For this reason, if an organic solvent such as the NMP is used as the solvent for the slurry for forming the inorganic particle layer, the solvent and the binder in the slurry can diffuse in the positive electrode mixture layer when the slurry is applied onto the positive electrode mixture layer. This causes the binder of the positive electrode mixture layer to swell, resulting in the problem of poor energy density of the positive electrode. Thus, in order to avoid such a problem, it is preferable that water be used as the solvent for the slurry for forming the inorganic particle layer and a water-based binder be used as the binder.

It is desirable that the mass ratio of the phosphate salt to the inorganic particles be from 1/20 to 2/1.

If the amount of the phosphate salt added is too large, the dispersibility of the water-based slurry becomes poor, causing the inorganic particles and the phosphate salt to aggregate. Consequently, it becomes difficult to carry out coating of the water-based slurry, and unevenness occurs in the inorganic particle layer. On the other hand, if the amount of the phosphate salt added is too small, the advantageous effect obtained by adding the phosphate salt cannot be obtained sufficiently.

### Other Embodiments

(1) Examples of the substances usable as the inorganic particles for forming the inorganic particle layer include rutile-type titanium oxide (rutile-type titania), aluminum oxide (alumina), zirconium oxide (zirconia), and magnesium oxide (magnesia). However, from the viewpoints of having stability in the battery (i.e., having low reactivity with lithium) and being low in cost, it is preferable to use aluminum oxide or rutile-type titanium oxide. It is preferable that the average particle size of the inorganic particles be 1 μm or less, more preferably within the range of from 0.1 μm to 0.8 μm.

It is preferable that the inorganic particle layer have a thickness of 4 μm or less, more preferably within the range of from 0.5 μm to 4 μm, and still more preferably within the range of from 0.5 μm to 2 μm. If the thickness of the inorganic particle layer is too small, the advantageous effects obtained by forming the inorganic particle layer (the trapping effect, for example) will be insufficient. On the other hand, if the thickness of the inorganic particle layer is too large, the high-rate capability and energy density of the battery may deteriorate.

(2) When a water-based binder is used as the binder, the water-based binder may be used in the form of emulsion resin or water-soluble resin. Although the material for the binder is not particularly limited, it is preferable that the material satisfy the following characteristics:

[A] Ensuring dispersion capability of the inorganic particles (for preventing re-aggregation).

[B] Ensuring adhesion capability that enables the inorganic particles to withstand the manufacturing process of the battery.

[C] Filling the gaps between the inorganic particles resulting from the expansion after absorbing the non-aqueous electrolyte.

[D] Causing less dissolution into the non-aqueous electrolyte. Preferable examples of the material include polytetrafluoroethylene (PTFE), polyacrylonitrile (PAN), styrene-butadiene rubber (SBR), modified substances thereof, derivatives thereof, copolymers containing acrylonitrile units, and polyacrylic acid derivatives. When it is considered important to obtain the above-listed characteristics (A) and (C) with a small amount of the binder, it is especially preferable to use a copolymer containing acrylonitrile units.

In order to ensure sufficient battery performance, it is preferable that the above-described effects can be obtained with a small amount of the binder. For this reason, it is preferable that the content of the water-based binder in the inorganic particle layer be 30 parts by mass or less, more preferably 10 parts by mass or less, and still more preferably 5 parts by mass, with respect to 100 parts by mass of the inorganic particles. The lower limit value of the amount of the water-based binder in the inorganic particle layer is generally 0.1 parts by mass or greater.

(3) A suitable method for dispersing the water-based slurry is a wet-type dispersion technique such as a technique using a bead mill or a Filmics mixer made by Primix Corp. Since it is preferable that the particle size of the inorganic particles be small, sedimentation of the slurry is considerable and a uniform film cannot be formed without a mechanical dispersion process. For this reason, a dispersion technique used for dispersing paint may be used preferably.

(4) Examples of the method for forming an inorganic particle layer on the positive electrode surface include die coating, gravure coating, dip coating, curtain coating, and spray coating. In order to prevent the decrease of the bonding strength caused by the diffusion of the solvent or the binder into the electrode, it is desirable to use a technique that is capable of high speed coating and that requires a shorter drying time. A preferable concentration of the solid content in the slurry greatly varies depending on the method of coating. For the spray coating, dip coating, and curtain coating, which are difficult to control the thickness of the coating mechanically, it is preferable that the concentration of the solid content be low, within the range of from 3 mass % to 30 mass %. On the other hand, for die coating, gravure coating, and the like, the concentration of the solid content may be higher, and it may preferably be within the range of from 5 mass % to 70 mass %.

(5) The positive electrode active material is not particularly restricted as long as it is capable of intercalating and deintercalating lithium and its potential is noble. Usable examples include lithium-transition metal composite oxides that have a layered structure, a spinel structure, or an olivine structure. In particular, the lithium-transition metal composite oxide having a layered structure is preferable from the viewpoint of achieving high energy density. Examples of the lithium-transition metal composite oxides include lithium-nickel composite oxides, lithium-nickel-cobalt composite oxides, lithium-nickel-cobalt-aluminum composite oxides, lithium-nickel-cobalt-manganese composite oxides, and lithium-cobalt composite oxides.

The present invention is not limited to the following preferred embodiments, and various changes and modifications are possible without departing from the scope of the invention.

### Preparation of Positive Electrode

Formation of Positive Electrode Mixture Layer

First, lithium cobalt oxide as the positive electrode active material, acetylene black as a carbon conductive agent, and PVDF (polyvinylidene fluoride) as a binder agent were mixed together at a mass ratio of 95:2.5:2.5. Thereafter, using NMP as a solvent, the mixture was mixed with a mixer (Combimix mixer made by Tokushu Kika Kogyo Co., Ltd.), to prepare a positive electrode mixture slurry. Next, the resultant positive electrode mixture slurry was applied onto both sides of a positive electrode current collector made of an aluminum foil, and the resultant material was then dried and calendered, whereby positive electrode active material layers were formed on both surfaces of the aluminum foil. The filling density of the positive electrode mixture layer was set at 3.60 g/cm³.

Formation of Inorganic Particle Layer

A water-based slurry for forming the inorganic particle layer was prepared. The water-based slurry was prepared using the following materials. Water was used as the solvent. Titanium oxide (made by Ishihara Sangyo Co., Ltd. under the trade name “CR-EL”, specifically, TiO₂ having no surface-treatment layer and an average particle size of 0.25 μm) was used as the inorganic particles. Lithium phosphate was used as the phosphate salt. A copolymer (elastic polymer) containing an acrylonitrile structure (acrylonitrile unit) was used as the water-based binder. CMC (carboxymethylcellulose) was used as a dispersing agent. The lithium phosphate used was prepared as follows. Lithium phosphate powder (made by Wako Pure Chemical Industries, Ltd.) was ground in an agate mortar, and thereafter classified with a 20 μm mesh.

Next, the inorganic particle layer was prepared as follows. Specifically, the lithium phosphate was weighted so that the amount of the lithium phosphate was 50 parts by mass with respect to 100 parts by mass of the inorganic particles (inorganic particles:lithium phosphate=2:1). The concentration of the solid content of the inorganic mixture was set at 40 mass %. Further, the water-based binder and the CMC were weighed so that the amount of the water-based binder was 3 parts by mass and that of the CMC was 0.2 parts by mass with respect to 100 parts by mass of the inorganic mixture, and these were subjected to a mixing and dispersing process using a Filmics mixer made by Tokushu Kika Kogyo Co., Ltd., to thereby prepare a water-based slurry. Thereafter, the prepared water-based slurry was coated onto a surface of the positive electrode mixture layer by gravure coating, and thereafter, the solvent, i.e., water, was removed by drying. Thus, an inorganic particle layer was formed on the surface of the positive electrode mixture layer. The thickness of the inorganic particle layers was set at a total of 4 μm on both sides (2 μm per each side).

### Preparation of Negative Electrode

First, a carbon material (graphite) as a negative electrode active material, CMC (carboxymethylcellulose sodium) as a dispersing agent, and SBR (styrene-butadiene rubber) as a binder agent were mixed at a mass ratio of 98:1:1 in an aqueous solution, to prepare a negative electrode mixture slurry. Next, the just-described negative electrode mixture slurry was applied onto both sides of a negative electrode current collector made of a copper foil. The resultant article was then dried and calendered, whereby a negative electrode was prepared. The filling density of the negative electrode mixture layer was set at 1.60 g/cc.

### Preparation of Non-Aqueous Electrolyte Solution

LiPF₆ was dissolved at a concentration of 1 mole/liter into a mixed solvent of 3:7 volume ratio of ethylene carbonate (EC) and diethyl carbonate (DEC), to prepare a non-aqueous electrolyte solution.

### Type of Separator

A polyethylene microporous film (film thickness 16 μm, average pore diameter 0.1 μm, porosity 47%) was used as the separator.

### Construction of Battery

First, respective lead terminals were attached to the positive electrode and the negative electrode prepared in the above-described manner. Then, the positive electrode and the negative electrode were arranged with separators interposed therebetween, and thereafter, they were spirally wound together. The resultant wound assembly was pressed into a flat shape, to thus prepare an electrode assembly. Next, the resultant electrode assembly was inserted into an aluminum laminate battery case, and thereafter, the above-described non-aqueous electrolyte solution was filled therein. Then, the opening of the aluminum laminate battery case was sealed. Thus, a battery was prepared.

This battery was designed to have an end-of-charge voltage of 4.4 V, and it was also designed so that the capacity ratio of the positive electrode and the negative electrode (the initial charge capacity of the negative electrode/the initial charge capacity of the positive electrode) became 1.08. The design capacity of the battery was set at 800 mAh.

### EXAMPLES

### Example 1

A battery was fabricated in the same manner as described in the just-described embodiment.

The battery fabricated in this manner is hereinafter referred to as a battery A1.

### Example 2

A battery was fabricated in the same manner as described in Example 1 above, except that, in preparing the water-based slurry for forming the inorganic particle layer, the mass ratio of the inorganic particles and the lithium phosphate was set at 1:2 (i.e., the amount of the lithium phosphate was 200 parts by mass with respect to 100 parts by mass of the inorganic particles).

The battery fabricated in this manner is hereinafter referred to as a battery A2.

### Example 3

A battery was fabricated in the same manner as described in Example 1 above, except that, in preparing the water-based slurry for forming the inorganic particle layer, the mass ratio of the inorganic particles and the lithium phosphate was set at 10:1 (i.e., the amount of the lithium phosphate was 10 parts by mass with respect to 100 parts by mass of the inorganic particles).

The battery fabricated in this manner is hereinafter referred to as a battery A3.

### Comparative Example 1

A battery was prepared in the same manner as described in Example 1, except that no inorganic particle layer was provided on the surface of the positive electrode mixture layer.

The battery fabricated in this manner is hereinafter referred to as a battery Z1.

### Comparative Example 2

A battery was prepared in the same manner as described in Example 1, except that lithium phosphate was not added to the inorganic particle layer.

The battery fabricated in this manner is hereinafter referred to as a battery Z2.

### Comparative Example 3

A battery was fabricated in the same manner as described in Example 1 above, except that no inorganic particle layer was provided on the surface of the positive electrode mixture layer and that lithium phosphate was added to the positive electrode mixture layer.

The positive electrode mixture slurry used in forming the positive electrode mixture layer was prepared as follows. Lithium cobalt oxide, acetylene black, PVDF, and lithium phosphate were mixed at a mass ratio of 94:2.5:2.5:1.0, and these were mixed with a mixer using NMP as a solvent, to prepare the positive electrode mixture slurry.

The battery fabricated in this manner is hereinafter referred to as a battery Z3.

### Experiment

The foregoing batteries A1 through A3 and Z1 through Z3 were charged and discharged one time under the following charge-discharge conditions, to measure the discharge capacity before storage test for each battery. Next, each battery was charged under the following charge conditions, and thereafter set aside for 20 days at 60° C.

Thereafter, each of the batteries was cooled to room temperature, and then discharged under the following discharge conditions, to measure the discharge capacity for the first time after storage test. Then, the residual capacity ratio of each of the batteries was calculated using the following equation (1). The results are shown in Table 1 below.

### Determination of Residual Capacity Ratio

Residual capacity ratio (%)=(Discharge capacity obtained at the first-time discharge after storage test/Discharge capacity obtained before storage test)×100 (1)

### Charge-Discharge Conditions

Charge Conditions

Each of the batteries was charged at a constant current of 1.0 It (800 mA) to a battery voltage of 4.4 V and thereafter further charged at a constant voltage of 4.4 V to a current of It/20 (40 mA).

Discharge Conditions

Each of the batteries was discharged at a constant current of 1.0 It (800 mA) to a battery voltage of 2.75 V.

Rest

A 10 minute rest was provided between the charge and the discharge.

TABLE 1

| | Positive electrode | | | | | |
|---|---|---|---|---|---|---|
| | Inorganic particle layer | | | Positive electrode | Amount of | |
| | | Addition of | Mass ratio of inorganic | mixture layer | lithium phosphate | Residual |
| | Inorganic | lithium | particle to lithium | Addition of lithium | in the battery | capacity ratio |
| Battery | particle layer | phosphate | phosphate | phosphate | (mg) | (%) |
| A2 | Present | Yes | 1:2 | No | 39.1 | 62.0 |
| A1 | | | 2:1 | | 19.5 | 63.1 |
| A3 | | | 10:1 | | 5.3 | 62.2 |
| Z1 | Absent | — | — | No | 0 | 50.7 |
| Z2 | Present | No | — | No | 0 | 60.8 |
| Z3 | Absent | — | — | Yes | 59.9 | 51.8 |

The batteries A1 through A3, in which the inorganic particle layer was formed on a surface of the positive electrode mixture layer and lithium phosphate was added to the inorganic particle layer, exhibited residual capacity ratios of 62.0% or greater. Thus, it was observed that they had high residual capacity ratios. In contrast, the battery Z1, in which no inorganic particle layer was formed on the surface of the positive electrode mixture layer, showed a residual capacity ratio of 50.7%; the battery Z2, in which the inorganic particle layer was formed on the surface of the positive electrode mixture layer but no lithium phosphate is added to the inorganic particle layer showed a residual capacity ratio of 60.8%; and the battery Z3, having no inorganic particle layer on the surface of the positive electrode mixture layer but containing lithium phosphate in the positive electrode mixture layer, showed a residual capacity ratio of 51.8%. All of the comparative examples showed residual capacity ratios lower than those of the batteries A1 through A3.

Next, the battery Z1 and the battery Z3 were compared to each other, both of which had no inorganic particle layer on the surface of the positive electrode mixture layer. The battery Z3, in which 59.9 mg of lithium phosphate was added in the positive electrode mixture layer, showed an improvement in residual capacity ratio by 1.1% over the battery Z1, in which no lithium phosphate was added to the positive electrode mixture layer.

In contrast, the battery Z2 and the battery A3 were compared to each other, both of which had the inorganic particle layer formed on the surface of the positive electrode mixture layer. The battery A3, in which 5.3 mg of lithium phosphate was added to the inorganic particle layer, showed an improvement in residual capacity ratio by 1.4% over the battery Z2, in which no lithium phosphate was added to the inorganic particle layer. Thus, although the amount of the lithium phosphate added was much smaller in the battery A3 than that in the battery Z3, the advantageous effect obtained by adding the lithium phosphate is more significant. Therefore, it will be appreciated that a more significant effect can be obtained when adding lithium phosphate to the inorganic particle layer than when adding lithium phosphate to the positive electrode mixture layer.

It is believed that these results of the experiments were obtained for the following reasons.

In the battery Z2, in which the inorganic particle layer is formed on the surface of the positive electrode mixture layer, the inorganic particle layer can trap the decomposition product of the electrolyte solution reacting at the positive electrode and the substance that dissolves away from the positive electrode active material (the substance is cobalt in the case where lithium cobalt oxide is used as the positive electrode active material as described above) because the inorganic particle layer exhibits the filtering function. For this reason, the storage performance of the battery Z2 is slightly improved over the battery Z1, in which no inorganic particle layer is formed on the surface of the positive electrode mixture layer. However, the positive electrode active material components cannot be inhibited from dissolving away from the positive electrode by merely providing the inorganic particle layer, so the storage performance cannot be improved significantly.

The non-aqueous electrolyte secondary battery has a structure such as to prevent moisture from entering the battery to a minimum. However, it is difficult to stop the entry of moisture completely. This means that moisture may exist inside the non-aqueous electrolyte secondary battery (for example, in the electrode plates). If moisture exists inside the battery, the storage performance deteriorates. Although not clear, it is believed that the reason is as follows. The non-aqueous electrolyte undergoes hydrolysis and produces a hydrofluoric acid. The resulting hydrofluoric acid causes the positive electrode active material components to dissolve away from the positive electrode, consequently lowering the positive electrode capacity. The hydrofluoric acid also causes the positive electrode binder to deteriorate, resulting in poor current collection performance in the positive electrode active material.

In view of the problem, it is conceivable to add lithium phosphate to the positive electrode (the positive electrode mixture layer) as in the battery Z3. This structure can improve the storage performance to some extent. Although the mechanism of the improvement in the storage performance is not clear, it is believed that the lithium phosphate and the hydrofluoric acid react with each other and produce a phosphoric acid, lithium fluoride, and the like, and as a result, the concentration of the hydrofluoric acid in the battery lowers, inhibiting the positive electrode active material and the positive electrode binder from suffering from the adverse effects. However, if the lithium phosphate is added to the positive electrode (the positive electrode mixture layer) as in the battery Z3, the lithium phosphate reacts with the electrolyte solution because the positive electrode has a high potential. As a consequence, the lithium phosphate causes surface modification, so the effect obtained by adding the lithium phosphate cannot be fully exhibited. Consequently, the concentration of the hydrofluoric acid in the battery cannot be lowered sufficiently.

Moreover, although it is desirable that the lithium phosphate be added to the positive electrode in a certain amount, the charge-discharge performance of the battery degrades if the amount of the lithium phosphate added to the positive electrode mixture layer is as large as that in the battery Z3. The reason is that, because lithium phosphate has no electron conductivity, the electron conductivity in the positive electrode active material is lost if lithium phosphate is added to the positive electrode mixture layer in an amount greater than a required amount.

For the just-described reasons, the battery Z3, in which lithium phosphate is added to the positive electrode mixture layer, cannot exhibit the advantageous effect of significantly improving the storage performance while at the same time inhibiting the charge-discharge performance.

In contrast, when the lithium phosphate exists in the inorganic particle layer as in the batteries A1 to A3, it is possible to inhibit the surface modification of the lithium phosphate that results from the reaction between the lithium phosphate and the electrolyte solution because the inorganic particle layer has almost no potential. As a result, the effect obtained by the addition of the lithium phosphate can be fully exhibited, and the concentration of the hydrofluoric acid in the battery is reduced significantly. Thereby, the adverse effects on the positive electrode active material and the positive electrode binder, for example, can be inhibited reliably. Moreover, even when the lithium phosphate is added in a certain amount, the problem of the electron conductivity loss in the positive electrode active material does not arise. Therefore, a required amount of lithium phosphate can be added without causing deterioration of the charge-discharge performance.

As described above, with the configurations of the batteries A1 to A3, the substance dissolving away from the positive electrode active material can be trapped by providing the inorganic particle layer, and the concentration of the hydrofluoric acid in the battery can be reduced significantly by adding lithium phosphate to the inorganic particle layer. This results in significant improvement in the storage performance. Moreover, since lithium phosphate is added to the inorganic particle layer, the deterioration of the charge-discharge performance resulting from adding lithium phosphate to the positive electrode mixture layer can be prevented.

Next, the amount of the lithium phosphate to be added to the inorganic particle layer will be discussed.

It is observed that the battery A2, in which 39.1 mg of lithium phosphate is add to the inorganic particle layer [the mass ratio of the lithium phosphate to the inorganic particles (the mass of the lithium phosphate/the mass of the inorganic particles) is 2/1], shows a lower residual capacity ratio than the battery A1, in which 19.5 mg of lithium phosphate is add to the inorganic particle layer [the mass ratio of the lithium phosphate to the inorganic particles is 1/2]. This means that, although it is preferable that the amount of the lithium phosphate to be added be large to some extent, the storage performance can be lowered if an excessive amount of lithium phosphate is added. The reason is believed to be as follows. If the amount of the lithium phosphate added is too large, the dispersibility of the water-based slurry becomes poor, causing the inorganic particles and the lithium phosphate to aggregate. Consequently, coating of the water-based slurry becomes difficult, causing unevenness in the inorganic particle layer. For this reason, it is desirable that the mass ratio of the lithium phosphate to the inorganic particles (the mass of the lithium phosphate/the mass of the inorganic particles) be restricted to 2/1 as in the battery A2, or even lower.

On the other hand, if the amount of the lithium phosphate added is too small, the effect obtained by adding the phosphate salt cannot be obtained sufficiently. For this reason, it is desirable that the mass ratio of the lithium phosphate to the inorganic particles be restricted to a slightly smaller value (1/20) than that in the battery A3 (1/10) or higher.

The present invention is applicable to the power sources for mobile information terminals, such as mobile telephones, notebook computers, and PDAs, as well as the power sources for the applications that require high power, such as HEVs and power tools.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A positive electrode for a non-aqueous electrolyte secondary battery comprising:
a positive electrode current collector;
a positive electrode mixture layer formed on at least one surface of the positive electrode current collector and containing a positive electrode active material; and
an inorganic particle layer formed on the positive electrode mixture layer, the inorganic particle layer containing inorganic particles, a phosphate salt, and a binder.

2. The positive electrode for a non-aqueous electrolyte secondary battery according to claim 1, wherein the phosphate salt is lithium phosphate.

3. The positive electrode for a non-aqueous electrolyte battery according to claim 1, wherein the binder is a water-based binder.

4. The positive electrode for a non-aqueous electrolyte secondary battery according to claim 1, wherein the mass ratio of the phosphate salt to the inorganic particles is from 1/20 to 2/1.

5. A non-aqueous electrolyte secondary battery comprising a positive electrode according to claim 1, a negative electrode, and a non-aqueous electrolyte.

6. A non-aqueous electrolyte secondary battery comprising a positive electrode according to claim 2, a negative electrode, and a non-aqueous electrolyte.

7. A non-aqueous electrolyte secondary battery comprising a positive electrode according to claim 3, a negative electrode, and a non-aqueous electrolyte.

8. A non-aqueous electrolyte secondary battery comprising a positive electrode according to claim 4, a negative electrode, and a non-aqueous electrolyte.
